(19) United States
(12) Patent Application Publication
(10) Pub. No.: US 2021/0158282 A1
(43) Pub. Date: May 27, 2021

(54) SHIPMENT MONITORING WITH LOCAL NOTIFICATION

(71) Applicant: The Board of Trustees of The University of Alabama, Tuscaloosa, AL (US)

(72) Inventor: Andrew Nathan Lemmon, Tuscaloosa, AL (US)

(21) Appl. No.: 17/168,712

(22) Filed: Feb. 5, 2021

Related U.S. Application Data
(63) Continuation of application No. 14/989,316, filed on Jan. 6, 2016.
(60) Provisional application No. 62/100,229, filed on Jan. 6, 2015.

(51) Int. Cl. G06Q 10/08; H04W 4/02

(52) U.S. Cl. CPC G06Q 10/0832; H04W 4/025; G06Q 10/0833

(57) ABSTRACT

Described herein are a device, system and method of a shipment monitor that provides local notification of a condition of a package that at least partially contains the shipment monitor. The shipment monitor may also have a power source that extracts energy from its environment to sustain ongoing operation of all or part of the shipment monitor system. Methods of use and a system for implementing the shipment monitor are also described.

### CROSS-REFERENCE TO RELATED APPLICATION

This application is a continuation application of U.S. non-provisional application Ser. No. 14/989,316 filed Jan. 6, 2016, which claims priority to and benefit of U.S. Provisional Patent Application Ser. No. 62/100,229 filed Jan. 6, 2015, both of which are fully incorporated by reference and made a part hereof.

### BACKGROUND

While shipment monitoring is not a new concept, there are limitations in the known technology and the way it is applied in practice. For example, many low-end shipment monitoring devices have no method of wireless real-time communication; therefore, any information recorded about the shipment such as, for example, temperature, shock, moisture, humidity, orientation/tilt and the like is not visible by the user until after the shipment arrives. Another category of shipment monitoring devices incorporates embedded real-time wireless communications capabilities. For this category of devices, the recurring cost of the wireless data service limits the market; battery life of this type of shipment monitor limits service availability; some international routes are not eligible this type of shipment monitor; and some lower-speed package delivery options are not eligible for this type of shipment monitor. Also, because present shipment monitors are placed within the package and only log data for review upon delivery of the package or are monitored remotely by the shipping service or the shipment monitor vendor, the lack of access to real-time shipment information by those in the presence of the package may limit the usefulness of monitoring package parameters to customers. For example, a delivery vehicle driver may have a package in his or her vehicle which has exceeded a temperature threshold; however, based on the current state of the art, this information would only be available to the end customer and possibly to users in the shipping call center. This information is not available to the driver, who may actually have the ability to take corrective action and prevent damage to the shipment.

Some current shipment monitoring systems rely on the end-user to monitor the shipment health and the responsibility for responding to impending shipment environmental problems such as over-temperature conditions falls to the end-user. The primary means of addressing such problems is for the originating end-user to initiate a second, identical shipment before the first (ruined) shipment has even been delivered. This is beneficial because it reduces the time between the original shipment initiation and the receipt of the good product as seen from the perspective of the recipient end-user, but this is a reactive process involving unnecessary waste and latency. With an enhanced notification system, the shipping agent can take an active role in preventing shipment damage and enhance both the reliability and speed of environmentally-sensitive shipment delivery.

Therefore, what are needed are devices, systems and methods that overcome challenges in the present art, some of which are described above.

### SUMMARY

Described herein are embodiments of a shipment monitor or embodiments of an enhancement to an existing shipment monitor to provide local notification associated with parameters of the package being monitored. Further, components of the shipment monitor, in one embodiment, can be provided power by an energy extraction mechanism such as a kinetic energy harvesting system allowing the monitoring of shipments having longer transit periods.

In one aspect, a shipment monitor is described. One embodiment of the shipment monitor comprises a sensor; a processing unit in communication with the sensor; a local notification mechanism in communication with the processing unit; and a power source that extracts energy from its environment to sustain ongoing operation of the processing unit, the local notification mechanism, or another part of the system; wherein the sensor senses one or more parameters associated with a shipment and the processing unit causes the local notification mechanism to provide an indicator associated with the one or more parameters. In various embodiments, the power source can be an energy harvesting mechanism. Also, in various embodiments, the indicator provided by the local notification mechanism can provide an audible, visible or haptic notification external to a package that includes the shipment monitor.

Another aspect of embodiments of the present invention comprises a method of monitoring and reporting the conditions of a package during transit. One embodiment of the method comprises placing a shipment monitor at least partially within a package for shipment; monitoring one or more parameters associated with the package during its shipment using the shipment monitor; extracting energy from its environment to at least partially power the shipment monitor during shipment of the package; and providing local notification regarding the one or more parameters associated with the package during its shipment. The method may further comprise extracting energy from its environment to power the shipment monitor using an energy harvesting device.

Yet another aspect of embodiments of the present invention comprises a local notification mechanism for attaching to an existing shipment monitor. One embodiment of the local notification mechanism comprises a connection circuit for communicatively connecting the local notification mechanism with an existing shipment monitor and a power source that extracts energy from its environment, wherein the local notification mechanism provides an indicator outside a package that at least partially contains the shipment monitor of one or more parameters that are sensed by the shipment monitor. In various embodiments, the indicator provided by the local notification mechanism provides an audible, visible or haptic notification external to the package that includes the shipment monitor.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other and like reference numerals designate corresponding parts throughout the several views:

FIG. 1 illustrates overview architecture of a shipment monitor according to embodiments of the present invention;

FIG. 2 illustrates an embodiment of a local notification mechanism for attaching to an existing shipment monitor;

FIG. 3 is an illustration of an exemplary system for monitoring at least the health of a package during shipment; and

FIG. 4 is an exemplary flowchart illustrating an embodiment of a method of monitoring a shipment of a package.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

### Shipment Monitor

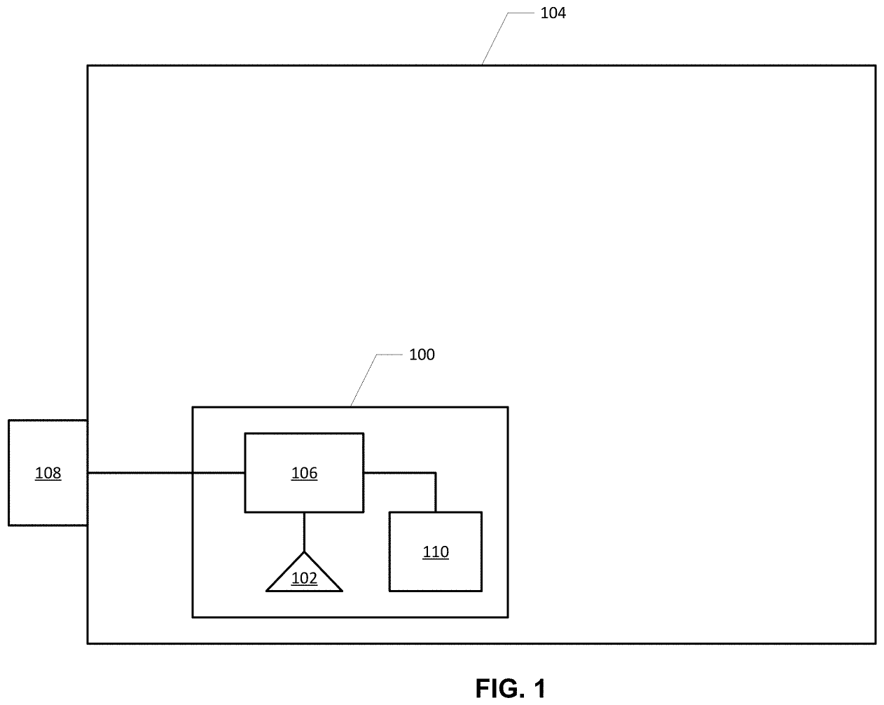

FIG. 1 illustrates overview architecture of a shipment monitor 100 according to embodiments of the present invention. As shown in FIG. 1, a sensor 102 senses one or more parameters associated with the shipment of a package 104. For example, the parameters sensed by the sensor 102 can include temperature, moisture, humidity, elevation, shock, vibration, tilt, orientation, oxygen content, barometric pressure, velocity, acceleration, light exposure, and the like. Though not shown in FIG. 1, it is to be appreciated that the shipment monitor 100 may comprise one or more sensors 102, each being able to sense a different parameter. Further comprising an embodiment of the shipment monitor 100 is a processing unit 106 that is operatively coupled with the sensor 102. For example, the processing unit 106 may be operatively coupled with the sensor 102 using wires, fiber optic, wireless communications, combinations thereof, and the like. In various embodiments, the processing unit 106 can include a processor, a micro-processor, a field-programmable gate array (FPGA), a logic circuit, and the like. As used herein, processor refers to a physical hardware device that executes encoded instructions for performing functions on inputs and creating outputs. Further comprising an embodiment of the shipment monitor 100 is a local notification mechanism 108 in communication with the processing unit 106. For example, the processing unit 106 may be in communication with the local notification mechanism 108 using wires, fiber optic, wireless communications, combinations thereof, and the like. The local notification mechanism 108 can provide a visual, audible or haptic indicator that is associated with one or more parameters of the shipment. This indicator is external to package 104, and is also visually, aurally, or haptically detectable by persons in the immediate vicinity of package 104. For example, the local notification mechanism 108 can include any one or more of a display, bell, buzzer, haptic device and the like. In one embodiment, the local notification mechanism 108 can be a low power display such as an electronic ink display. The display can be used to display information about one or more parameters of the shipment such as temperature, moisture, humidity, elevation, shock, vibration, tilt, orientation, oxygen content, barometric pressure, velocity, acceleration, light exposure, duration of shipment, and the like.

Further comprising one embodiment of a shipment monitor 100 is a power source 110 that extracts energy from its environment. The power source 110 can be used to provide power to the processing unit 106 and any other components of the shipment monitor 100 that require power. The power source 110 can further comprise a battery, a capacitor, or other energy storage device connected with the energy extraction mechanism in order to store available energy until it is needed by the shipment monitor. The power source 110 can comprise an energy harvesting mechanism such as a kinetic energy harvesting device, a photovoltaic energy device, a radio-frequency energy harvesting device, and the like. In one embodiment, the power source 110 can comprise a kinetic energy harvesting device that is comprised of one or more piezoelectric transducers. Vibration, shock and other disturbances and motion incurred during the normal course of shipment can be converted to electrical energy using such a kinetic energy harvesting mechanism. In one aspect, the power source 110 can be comprised of a combination of energy storage devices and energy harvesting devices. For example, the power source 110 can further be comprised of a battery, a capacitor or other energy storage device in combination with a kinetic energy harvesting device. In one aspect, the energy harvesting device can be used to recharge the energy storage device.

Various embodiments of the shipment monitor 100 can have power conserving operation modes. In one embodiment, the shipment monitor 110 can have sleep and wake modes that can be adjusted by programming the processing unit 106. One method commonly employed in the art is to program the processing unit 106 to sleep for a period of time; wake; take sensor 102 readings of the one or more parameters associated with the shipment; and subsequently record the sensor readings internally for later retrieval, or transmit the updated sensor readings over a wireless communication link to the end-user. In embodiments of the current invention, a similar procedure is used, except that the processing unit 106 updates the local notification mechanism 108 with the newly-acquired sensor 102 information before going back into a sleep mode to conserve energy. In one embodiment for which an electronic ink display is used as part of the local notification system 108, the processing unit 106 will provide a timestamp to the local notification system 108 along with the sensor 102 information so that the aging of the sensor 102 data will be visible to the nearby personnel who may interact with the local notification system 108. In another embodiment, the shipment monitor 100 can have its processing unit 106 to provide a signal to the local notification mechanism 108 if one of the sensed one or more parameters associated with the shipment exceeds or falls below a threshold value. For example, if temperature is being sensed by a sensor and the temperature inside the package falls below the freezing temperature for a substance within the package, an audible or visible alarm can be triggered to notify nearby shipping company personnel to move the package to a warmer environment.

In one embodiment, the shipment monitor 100 can further comprise a memory (not shown in FIG. 1) in communication with the processing unit 106. Values for at least a portion of the one or more parameters sensed by the sensor 102 can be stored in the memory as well as programming instructions for programming the processing unit 106.

In yet another embodiment, the shipment monitor 100 can further comprise a global positioning system (GPS) receiver (not shown in FIG. 1) that can be used to track the location of the shipment monitor 100 during shipment. For example, the shipment monitor 100 can further comprise a wireless network interface in communication with at least the processing unit 106. The wireless network interface can be used to at least intermittently wirelessly transmit information to or from the shipment monitor 100. For example, the location of the shipment monitor 100, as determined by the GPS receiver, as well as one or more parameters as measured by the sensor 102, can be wirelessly transmitted to a tracking system that can be used to track the locations and conditions of packages during shipment.

Another aspect of the invention pertains to an enhancement for existing package-sensors such as those used in the SenseAware℠ shipment monitoring service offered by FedEx (FedEx Corporation, Memphis, Tenn. USA). Embodiments of the current invention can extend the functionality of existing shipment sensor systems by providing a local notification such as an externally-viewable display (and/or an audible beeper) on the surface of a package containing the shipment monitor. This display offers real-time monitoring of internal environmental conditions (i.e., package “health”) to any individual in physical proximity to the package. Individuals who could take advantage of this information include the employees of the freight carrier associated with the shipment, among others. This increased visibility of package environmental conditions would then permit these individuals to take a more active role in monitoring environmental conditions and correcting problems before shipment damage can result.

For example, the external display could indicate an over-temperature condition for a package sitting on a shipping dock at a sort facility during hot weather. Even if the current system is able to notify the end user of a potential over-temperature condition, the end user is not in a position to take corrective action. The freight carrier employees, on the other hand, are in a position to take corrective action, and by providing local indication to them they have the information necessary to do so.

In one aspect, the local notification mechanism can further comprise a power source such as an energy-harvesting apparatus as described herein. Such a power source can power the local notification system without placing an additional burden on the power supply of the package sensor. In one aspect, the package-based energy harvesting system can provide some run-time extension (or battery recharge) capability to the package sensor.

In another aspect, the power source 110 can be utilized to extend the availability of the shipment monitor 100 beyond what would be practically realizable using a traditional power source (such as a battery) under certain conditions. For example, in one embodiment, the power source 110 may be comprised of one or more piezoelectric transducers, which transform vibration, shock and other mechanical disturbances and into electrical energy to power shipment monitor 100. In this case, as long as the shipment remains in motion, the power source 110 has the capability to provide power to the other subsystems within shipment monitor 100. In certain cases (such as ocean-going freight) this capability may far outlast the operating lifetime expected for a traditional shipment monitor powered by a battery. In other cases which involve freight or goods which remain stationary for long periods of time, this solution does not provide long periods of battery-less operation. However, in these cases, a new benefit emerges for the present invention. That benefit is related to the idea of “opportunistic” energy harvesting: whenever energy is available, the shipment monitor can harvest kinetic energy, wake up, and become aware of its environment. This “opportunistic” sensing and reporting scenario is well-suited for location awareness and security applications. In such applications, the fact that the monitored object is moving (along with its location) is the information of interest; in the present invention this capability could, in theory, be supported for an indefinite duration. This would make the present invention an ideal choice for long-term, maintenance-free tracking of assets which are intended to remain in one location.

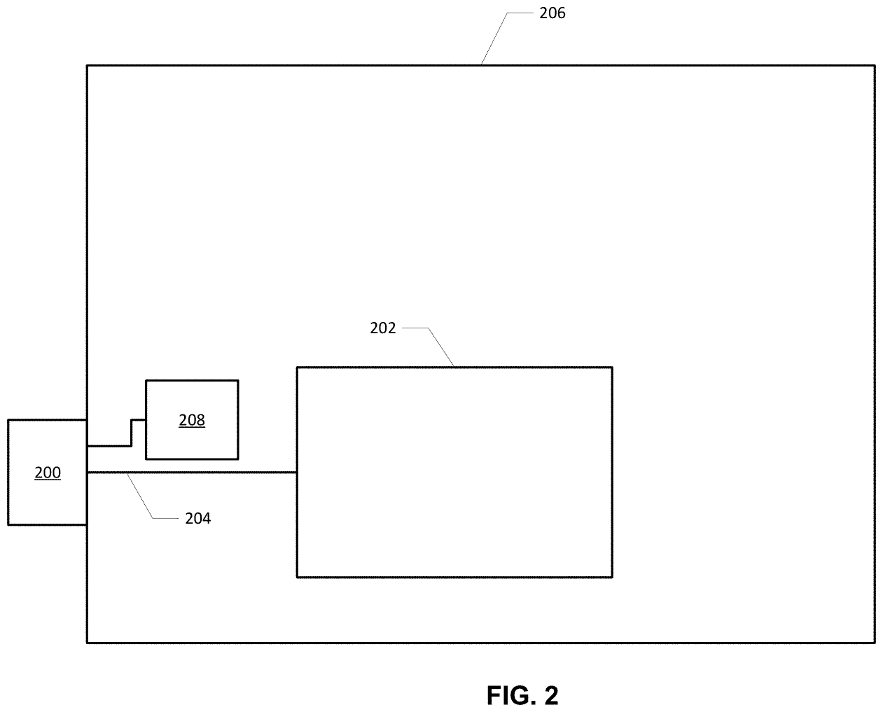

FIG. 2 illustrates an embodiment of a local notification mechanism 200 for attaching to an existing shipment monitor 202. One embodiment of the mechanism 200 comprises a connection circuit 204 for communicatively connecting the local notification mechanism 200 with the shipment monitor 202. The connection circuit can be a wired circuit (including fiber optics), wireless, or combinations thereof. The local notification mechanism 200, in concert with the existing shipment monitor 202, can provide an indicator outside a package 206 that at least partially contains the shipment monitor 202. Optionally, the mechanism 200 can further comprise associated sensors that monitor the “health” of package 206. The indicator provided by the local notification mechanism 200 can be an audible, visible or haptic notification external to the package 206 that includes the shipment monitor 202. For example, the local notification mechanism 200 can include any one or more of a display, bell, buzzer, haptic device and the like. In one aspect, the local notification mechanism 200 can include a display such as, for example, a low-power display such as an electronic ink display.

As noted above, the local notification mechanism may further comprise a power source 208 that extracts energy from its environment to sustain ongoing operation of the local notification mechanism 200. The power source 208 can be located within or external to the package 206. In various aspects, the power source 208 may further comprise an energy storage device such as a battery, capacitor and the like, that works cooperatively with the energy extraction power source. The power source 208 may comprise an energy harvesting mechanism such as one or more of a kinetic energy harvesting device, a photovoltaic energy device, a radio-frequency energy harvesting device, and the like. One embodiment of a kinetic energy harvesting mechanism comprises one or more piezoelectric transducers that can convert vibration, shock and movement into electrical energy. As noted above, the power source may be used to power and or recharge a power source for an existing shipment monitor 202. In various aspects, the connection circuit 204 for communicatively connecting the local notification mechanism 200 with the existing shipment monitor 202 may comprise a wired circuit (including fiber optic), a wireless circuit, or a combination of wired and wireless.

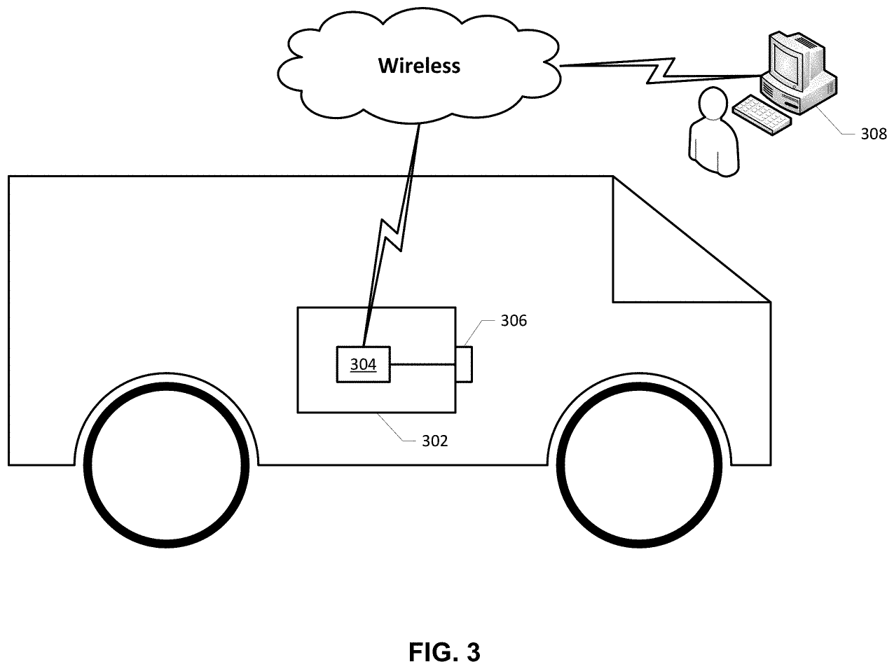

FIG. 3 is an illustration of an exemplary system for monitoring at least the health of a package 302 during shipment. The package 302 is equipped with a shipment monitor 304 having a local notification mechanism 306. The local notification mechanism 306 can be as described in relation to FIGS. 1 and 2. The shown embodiment of a shipment monitor 304 comprises a wireless network interface that can be used to at least intermittently wirelessly transmit information to or from the shipment monitor 304 to a computing system 308. Any wireless network and protocol can be used to enable communications between the shipment monitor 304 and the remote computing system 308. In this manner, in addition to the local alert and notification provided by the local notification mechanism 306, the health of the package 302 can also be monitored remotely. The health parameters associated with the package 302 that can be monitored can include, for example, temperature, moisture, humidity, elevation, shock, vibration, tilt, orientation, oxygen content, barometric pressure, velocity, acceleration, light exposure, and the like. The shipment monitor 304 can comprise a power source such as a battery, a capacitor, or other energy storage device and an energy harvesting mechanism such as a kinetic energy harvesting device, a photovoltaic energy device, a radio-frequency energy harvesting device, and the like. In one embodiment, the power source can comprise a kinetic energy harvesting device that is comprised of one or more piezoelectric transducers. Vibration, shock and other disturbances and motion incurred during the normal course of shipment can be converted to electrical energy using a kinetic energy harvesting mechanism. In one aspect, the power source can be comprised of a combination of energy storage devices and energy harvesting devices. For example, the power source can be comprised of a battery in combination with a kinetic energy harvesting device. In one aspect, the energy harvesting device can be used to recharge the energy storage device.

Furthermore, in one embodiment the shipment monitor 304 can comprise a global positioning system (GPS) receiver that can be used to track the location of the shipment monitor 304 during shipment using the wireless network interface and the remote computing system 308.

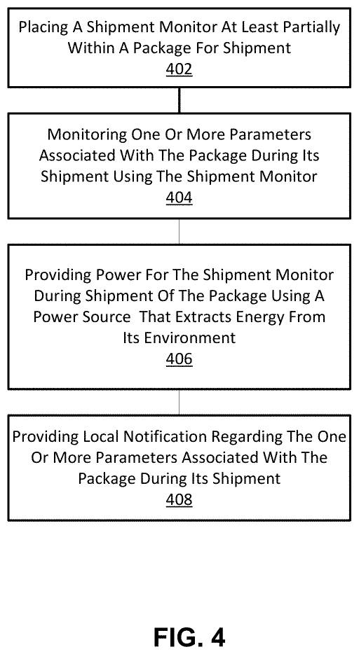

FIG. 4 is an exemplary flowchart illustrating an embodiment of a method of monitoring a shipment of a package. This method comprises step 402, placing a shipment monitor at least partially within a package for shipment. At step 404, one or more parameters associated with the package are monitored during its shipment using the shipment monitor. For example, the one or more parameters can include temperature, moisture, humidity, elevation, shock, vibration, tilt, orientation, oxygen content, barometric pressure, velocity, acceleration, light exposure, and the like that are monitored using one or more sensors of the shipment monitor. At step 406, a power source associated with the shipment monitor extracts energy from its environment to provide power for the shipment monitor during shipment of the package. In one embodiment, the power source can include an energy storage mechanism such as a battery and an energy harvesting mechanism. For example, the energy harvesting mechanism can include one or more of a kinetic energy harvesting device, a photovoltaic energy device, a radio-frequency energy harvesting device, and the like. In one embodiment, the kinetic energy harvesting device comprises one or more piezoelectric transducers. At step 408, local notification is provided regarding the one or more parameters associated with the package during its shipment. For example, the local notification can be provided by a local notification mechanism that provides an audible, visible or haptic notification external to the package that at least partially includes the shipment monitor. The local notification mechanism includes any one or more of a display, bell, buzzer, haptic device and the like. The local notification mechanism can be a low-power display such as an electronic ink display.

In various other embodiments the shipment monitor can include one or more of a global positioning system (GPS) receiver that tracks the location of the shipment monitor during transit, and a wireless network interface used to at least intermittently wirelessly transmit information to or from the shipment monitor.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A shipment monitor for a package being shipped,
the shipment monitor, comprising:
a processing unit in communication with one or more sensors, wherein the one or more sensors measure at least one parameter of the package being shipped and communicate measured values to the processing unit, the processing unit further including a memory in communication with the one or more sensors and for storing measured values received from the one or more sensors;
a local notification mechanism in communication with the processing unit, wherein the local notification system includes one or more of a bell, buzzer, or haptic device;
a power source that extracts energy from its environment to sustain ongoing operation of the processing unit and the local notification mechanism, wherein the measured values are received by the processing unit and the processing unit causes the local notification mechanism to provide an indicator associated with the measured values, wherein the one or more sensors, the processing unit, the local notification mechanism, and the power source are placed inside the package and are not readily visible from outside the package; and
a visual display on an external portion of the package, the visual display communicatively connected to the processing unit, wherein the visual display displays an indication of select ones of the measured values.

2. (canceled)

3. The shipment monitor of claim 1, further comprising a global positioning system (GPS) receiver that is used to track the location of the shipment monitor.

4. The shipment monitor of claim 1, further comprising a wireless network interface in communication with at least the processing unit, wherein the wireless network interface is used to at least intermittently wirelessly transmit information to or from the shipment monitor during shipment of the package that contains the shipment monitor.

5. (canceled)

6. The shipment monitor of claim 1, wherein the one or more parameters sensed by the one or more sensors include temperature, moisture, humidity, elevation, shock, vibration, tilt, orientation, oxygen content, barometric pressure, velocity, acceleration, and any light exposure inside the package.

7. The shipment monitor of claim 1, wherein the processing unit includes a processor, a micro-processor, a field-programmable gate array (FPGA), or a logic circuit.

8. (canceled)

9. The shipment monitor of claim 1, wherein the local notification mechanism includes a low-power, electronic ink display.

10. (canceled)

11. (canceled)

12. The shipment monitor of claim 1, wherein the power source is used to charge an onboard battery.

13. The shipment monitor of claim 12, wherein the power source comprises an energy harvesting mechanism.

14. The shipment monitor of claim 13, wherein the energy harvesting mechanism includes one or more of a kinetic energy harvesting device, a photovoltaic energy device, or a radio-frequency energy harvesting device.

15. The shipment monitor of claim 14, wherein the kinetic energy harvesting device comprises one or more piezoelectric transducers.

16. A method of monitoring a shipment of a package comprising:
placing a shipment monitor at least partially within the package, wherein the shipment monitor comprises:
a processing unit in communication with one or more sensors, wherein the one or more sensors measure at least one parameter of the package being shipped and communicate measured values to the processing unit, the processing unit further including a memory in communication with the one or more sensors and for storing measured values received from the one or more sensors;
a local notification mechanism in communication with the processing unit, wherein the local notification system includes one or more of a bell, buzzer, or haptic device;
a power source that extracts energy from its environment to sustain ongoing operation of the processing unit and the local notification mechanism, wherein the measured values are received by the processing unit, wherein the one or more sensors, the processing unit, the local notification mechanism, and the power source are placed inside the package and are not readily visible from outside the package; and
a visual display on an external portion of the package, the visual display communicatively connected to the processing unit, wherein the visual display displays an indication of select ones of the measured values;
monitoring the one or more parameters associated with the package during its shipment using the shipment monitor;
providing power for the shipment monitor during shipment of the package using the power source that extracts energy from its environment;
providing, by the processing unit, local notification by the local notification mechanism, and indicator associated with the measured values regarding the one or more parameters associated with the package during its shipment; and
providing, by the processing unit, an indication of select ones of the measured values on the visual display.

17. The method of claim 16, wherein the shipment monitor comprises a global positioning system (GPS) receiver that tracks a location of the shipment monitor during shipment.

18. The method of claim 16, wherein the shipment monitor further comprises a wireless network interface used to at least intermittently wirelessly transmit information to or from the shipment monitor during a shipment of a package that contains the shipment monitor using the wireless network interface.

19. (canceled)

20. The method of claim 16, wherein monitoring one or more parameters associated with the package during its shipment using the shipment monitor comprises sensing one or more parameters including temperature, moisture, humidity, elevation, shock, vibration, tilt, orientation, oxygen content, barometric pressure, velocity, acceleration, and light exposure detected inside the package using the one or more sensors.

21. The method of claim 16, wherein the processing unit includes one or more of a processor, a micro-processor, a field-programmable gate array (FPGA), or a logic circuit.

22. (canceled)

23. The method of claim 16, wherein the visual display includes a low-power, electronic ink display.

24. (canceled)

25. (canceled)

26. The method of claim 16, further comprising using the power source that extracts energy from its environment to charge an onboard battery.

27. The method of claim 26, wherein the power source that extracts energy from its environment comprises an energy harvesting mechanism.

28. The method of claim 27, wherein the energy harvesting mechanism includes one or more or a kinetic energy harvesting device, a photovoltaic energy device, or a radio-frequency energy harvesting device.

29. The method of claim 28, wherein the kinetic energy harvesting device comprises one or more piezoelectric transducers.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
